(19) United States
(12) Patent Application Publication
(10) Pub. No.: US 2007/0049489 A1
(43) Pub. Date: Mar. 1, 2007

(54) Redox active mass for a chemical looping combustion process

(76) Inventors: Thierry Becue, Lyon (FR); Karin Marchand, Lyon (FR); Arnold Lambert, Chavanay (FR); Etienne Lebas, Vienne (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/491,038

(22) Filed: Jul. 24, 2006

(30) Foreign Application Priority Data
Jul. 29, 2005 (FR) 05/08.184

(51) Int. Cl. B01J 23/10

(52) U.S. Cl. 502/304

(57) ABSTRACT

The present invention relates to a new type of redox mass that can be used in any chemical looping combustion process, said mass comprising a binder containing at least cerine-zirconia.

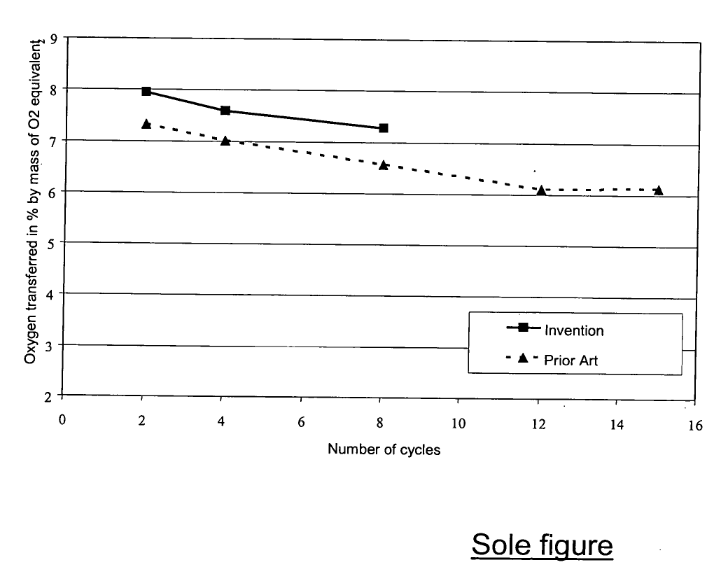

### FIELD OF THE INVENTION

The field of the present invention relates to energy production, gas turbines, boilers and furnaces, notably for the petroleum industry, the glass industry and the cement industry.

The field of the invention also concerns the use of these means for producing power, heat or steam.

The field of the invention more particularly covers the devices and processes allowing, by means of redox reactions of an active mass referred to as redox mass, to produce a hot gas from a hydrocarbon or a mixture of hydrocarbons, and to isolate the carbon dioxide produced so as to be able to capture it.

The worldwide power demand increase leads to build new thermal power plants and to emit increasing amounts of carbon dioxide that are harmful to the environment. Capture of the carbon dioxide with a view to its sequestration has thus become an imperative necessity.

One of the techniques that can be used to capture carbon dioxide consists in using redox reactions of an active mass in order to decompose the combustion reaction into two successive reactions. A first oxidation reaction of the active mass with air or a gas acting as the oxidizer allows, as a result of the exothermic nature of the oxidation reaction, to obtain a hot gas whose energy can be used thereafter. A second reduction reaction of the active mass thus oxidized by means of a reducing gas then allows to obtain a re-usable active mass as well as a gas mixture essentially comprising carbon dioxide and water.

One advantage of this technique is that it allows to readily isolate the carbon dioxide in a gas mixture practically free of oxygen and nitrogen.

In the text hereafter, the chemical looping combustion process described is a method using a redox mass referred to as active mass, successively going from an oxidized state to a reduced state, then from the reduced state to the initial oxidized state.

This process will be referred to hereafter in short as CLC (chemical looping combustion), thus referring to a loop redox process on an active mass.

The present invention also applies to the field of hydrogen production by means of such a chemical looping combustion process. In this application, the hydrocarbon or the hydrocarbon mixture is mainly reduced in form of carbon monoxide and hydrogen.

A complete description of the chemical looping combustion method can be found in French patent applications No. 02-14,071 for the rotary version and No. 04-08,549 for the simulated rotary version. It can be reminded that this process can also be implemented in form of a circulating bed with active mass particles of the order of one hundred microns.

### BACKGROUND OF THE INVENTION

U.S. Pat. No. 5,447,024 describes a CLC process comprising a first reduction reactor wherein an active mass reduction reaction is carried out by means of a reducing gas, and a second oxidation reactor allowing to restore the active mass in the oxidized state by means of an oxidation reaction with dampened air.

The active mass going alternately from the oxidized form to the reduced form and vice versa follows a redox cycle. It can be noted that, generally speaking, the terms oxidation and reduction are used in connection with the oxidized or reduced state of the active mass respectively. The oxidation reactor is the reactor wherein the redox mass is oxidized and the reduction reactor is the reactor wherein the redox mass is reduced.

The gaseous effluents from these two reactors are preferably fed into the gas turbines of a power plant. The method described in this patent allows to isolate the carbon dioxide in relation to the nitrogen, which thus facilitates capture of the carbon dioxide.

The aforementioned patent uses the circulating bed technology to allow continuous change of the active mass from the oxidized state to the reduced state.

Thus, in the reduction reactor, the active mass (MₓO_{y}) is first reduced to the state MₓO_{y-2n+m/2} by means of a hydrocarbon CₙHₘ that is correlatively oxidized to CO₂ and H₂O, according to reaction (1), or possibly to mixture CO+H₂ according to the proportions used.
CₙHₘ+MₓO_{y}→nCO₂+m/2H₂O+MₓO_{y-2n+m/2} (1)

In the oxidation reactor, the active mass is restored to its oxidized state (MₓO_{y}) on contact with air according to reaction (2) prior to being fed back into the first reactor.
MₓO_{y-2n+m/2}+(n+m/4)O₂→MₓO_{y} (2)

The same patent claims as the active mass the use of the redox pair NiO/Ni, alone or associated with binder YSZ (defined by zirconia stabilized by yttrium, also referred to as yttriated zirconia).

The advantage of a binder in such an application is to increase the mechanical strength of the particles, too weak to be used in a circulating bed when NiO/Ni is used alone.

Yttriated zirconia being furthermore an ion conductor for the O²⁻ ions at the working temperatures, the reactivity of the NiO/Ni/YSZ system is improved.

Many types of binder, besides the aforementioned yttriated zirconia (YSZ), have been studied in the literature in order to increase the mechanical strength of the particles at a lower cost than with YSZ. Examples thereof are alumina, metal aluminate spinels, titanium dioxide, silica, zirconia, kaolin.

In general terms, YSZ however remains the binder that is considered to be the most efficient because of the aforementioned ionic conductivity.

Furthermore, in U.S. Pat. No. 6,605,264, mixed oxides of cerine-zirconia type are described in an automobile post-combustion application for oxygen storage/destorage and they are also, like yttriated zirconia, ionic conductors for O²⁻ ions.

They are generally used as supports for precious metals and they allow adjustment of the oxygen concentration in exhaust gases for 3-way catalysis. They then appear as catalyst supports, generally mixed with other oxides.

The present invention thus constitutes a new application of these mixed cerine-zirconia type oxides in the field of processes using a redox active mass, a new application wherein they will act both as oxides taking part in the storage and destorage of O₂, and as binders increasing the mechanical strength, which is particularly interesting in the case of an active mass used in a circulating bed.

### SUMMARY OF THE INVENTION

The invention relates to a redox active mass, notably intended for chemical looping combustion processes, characterized in that said mass comprises, on the one hand, a redox pair or set of pairs selected from among the group consisting of: CuO/Cu, Cu₂O/Cu, NiO/Ni, Fe₂O₃/Fe₃O₄, FeO/Fe, Fe₃O₄/FeO, MnO₂/Mn₂O₃, Mn₂O₃/Mn₃O₄, Mn₃O₄/MnO, MnO/Mn, Co₃O₄/CoO, CoO/Co and, on the other hand, a binder containing at least one mixed cerine-zirconia oxide of general formula CeₓZr₁₋ₓO₂, with 0.05<x<0.95 and preferably 0.5<x<0.9.

The redox mass can come in form of a powder, balls, extrudates, or of a washcoat deposited on a monolith type substrate.

The proportion of binder in the redox mass can range from 10% to 95% by weight, preferably from 20% to 80% by weight, and more preferably from 30% to 70% by weight.

It is possible to use as the binder either cerine-zirconia alone, or cerine-zirconia mixed with other types of binder such as alumina, spinel type aluminates, silica, titanium dioxide, kaolin, YSZ, perovskites.

The redox mass according to the invention is characterized in that the binder it uses contains at least a certain proportion of cerine-zirconia, and this proportion can range from 0.1 to 1, preferably from 0.5 to 1.

The new type of redox mass according to the invention is thus characterized by the use of a binder containing cerine-zirconia, and the redox pair can be selected from among the subgroup consisting of NiO/Ni, CuO/Cu, Fe₂O₃/Fe₃O₄, Mn₃O₄/MnO, CoO/Co.

The binder used in the redox mass according to the present invention allows to increase by at least 10%, preferably by at least 15% the oxygen transfer capacity between the oxidation reactor and the reduction reactor.

The redox mass according to the present invention can be used according to the circulating bed, rotary reactor or simulated rotary reactor applications described in French patent applications No. 02-14,071 and No. 04-088,549.

### DETAILED DESCRIPTION

The present invention relates to the use of a new type of active mass in CLC type processes. These processes generally involve two distinct reactors for carrying out, on the one hand, in a reactor referred to as reduction reactor, reduction of the active mass by means of a hydrocarbon, or more generally of a reducing gas, allowing to correlatively generate an energy-carrying hot effluent and, on the other hand, in a reactor referred to as oxidation reactor, restoration of the active mass to the oxidized state thereof through the combustion of hydrocarbons, by segregating the CO₂ formed that is generally mixed with steam.

The redox active mass is made up of a first element referred to as redox pair, selected from among the group consisting of the metal oxides as follows: CuO/Cu, Cu₂O/Cu, NiO/Ni, CoO/Co, Fe₂O₃/Fe₃O₄, FeO/Fe, Fe₃O₄/FeO, MnO₂/Mn₂O₃, Mn₂O₃/Mn₃O₄, Mn₃O₄/MnO, MnO/Mn, Co₃O₄/CoO, CoO/Co, and of a second element referred to as binder which, within the scope of the invention, contains at least one mixed cerine-zirconia oxide and preferably a solid cerine-zirconia solution, possibly mixed with other types of binder.

The first element can also be made up of any mixture of metal oxides of the aforementioned group. The proportion of binder in the redox mass ranges between 10% and 95% by weight, preferably between 20% and 80% by weight, and more preferably between 30% and 70% by weight.

The reduction reactor is generally operated at temperatures usually ranging between 500° C. and 1000° C., the metal oxide being reduced by the hydrocarbon(s) according to reaction (1), and the solid cerine-zirconia solution reacting according to reaction (3):
2CeO₂+CₙHₘ->Ce₂O₃+xCO₂+yH₂O (3)

In comparison with the YSZ binder, with an iso-content in metal oxide, the binder used in the present invention allows to carry more oxygen from the oxidation reactor to the reduction reactor.

### COMPARATIVE EXAMPLE

In this example, we compare the performances of a redox mass according to the prior art and of a redox mass according to the present invention.

The redox mass according to the prior art is a nickel oxide NiO using as the binder an yttriated zirconia solution prepared as follows:

Ni(NO₃)₂, Y(NO₃)₃ and ZrO(NO₃)₂ are mixed in aqueous solution, then this mixture is added to a 25% ammonia solution, at ambient temperature. After stirring for 12 h, the mixture is filtered, dried, then calcined at 600° C. for 2 h, so as to obtain a material comprising 35% by mass of NiO, and a solid yttrium-stabilized zirconia solution (confirmed by X-ray diffraction) containing 84% by mass of zirconia and 16% by mass of yttria (i.e. a zirconia yttriated at 9% by mole to Y₂O₃).

The redox mass according to the present invention uses the same metal oxide NiO with, as the binder, a solid cerine-zirconia solution prepared as follows:

Ni(NO₃)₂, Ce(NO₃)₃ and ZrO(NO₃)₂ are mixed in aqueous solution, then this mixture is added to a 25% ammonia solution, at ambient temperature. After stirring for 12 h, the mixture is filtered, dried, then calcined at 600° C. in an air stream for 2 h, so as to obtain a material comprising 27% by mass of NiO, and a solid cerine-zirconia solution (confirmed by X-ray diffraction) containing 69% by mass of cerine and 31% by mass of zirconia.

The two redox masses are tested in a fixed bed in a quartz reactor placed in an electrically heated oven. The fixed bed contains 125 mg redox mass evenly dispersed in 5 g silicon carbide. Silicon carbide is inert towards the reactions involved and its function is only to dilute the redox mass within the test reactor.

The reduction/oxidation cycles were simulated by injecting successively a methane pulse (50 Nl/h nitrogen containing 5% CH₄), then an oxygen pulse at a time interval of 120 seconds. The oxidation and reduction temperature is 850° C.

The size of the redox mass particles used for the comparative test ranges between 40 and 100 microns with an average size of 70 microns.

The sole FIGURE shows the amount of O₂ equivalent released during reduction of the particles (ordinate) in relation to the mass of particles used, as a function of the number of redox cycles (abscissa).

The amount of O₂ equivalent is calculated from the amounts of CO₂, CO and H₂O formed during the reaction, i.e. 1 mole CO₂ corresponds to 1 mole CO₂ consumed, 1 mole CO corresponds to ½ mole CO₂ consumed, 1 mole H₂O corresponds to ½ mole CO₂ consumed. The mass amount of CO₂ obtained on the basis of the previous equivalences from the analysis of the combustion effluents is related to the mass of redox particles.

Despite the substantially lower proportion of NiO in the redox mass particles according to the invention (27% for the particles according to the invention versus 35% for the particles according to the prior art), the amount of oxygen delivered by the redox mass according to the invention is larger than with the redox mass according to the prior art.

The cerine-zirconia therefore fulfils an oxygen storage purpose in the oxidation reactor, and an oxygen destorage purpose in the reduction reactor.

The oxygen transfer capacity of the redox mass according to the present invention (cerine-zirconia) is higher by 15% than that of the redox mass according to the prior art (yttriated zirconia).

1) Redox mass intended for chemical looping combustion processes, characterized in that said redox mass comprises, on the one hand, a redox pair or set of pairs selected from among the group consisting of: CuO/Cu, Cu₂O/Cu, NiO/Ni, Fe₂O₃/Fe₃O₄, FeO/Fe, Fe₃O₄/FeO, MnO₂/Mn₂O₃, Mn₂O₃/Mn₃O₄, Mn₃O₄/MnO, MnO/Mn, Co₃O₄/CoO, CoO/Co and, on the other hand, a binder containing at least one mixed cerine-zirconia oxide (Ce/Zr) of general formula CeₓZr₁₋ₓO₂, with 0.05<x<0.95 and preferably 0.5<x<0.9.

2) Redox mass as claimed in claim 1, wherein the proportion of binder in said redox mass ranges from 10% to 95% by weight, preferably from 20% to 80% by weight and more preferably from 30% to 70% by weight.

3) Redox mass as claimed in claim 1, wherein the redox pair or set of pairs is selected from among the subgroup consisting of NiO/Ni, CuO/Cu, Fe₂O₃/Fe₃O₄, Mn₃O₄/MnO, CoO/Co.

4) Redox mass as claimed in claim 1, wherein the binder allows to increase by at least 10%, preferably by at least 15% the oxygen transfer capacity between the oxidation reactor and the reduction reactor.

5) Redox mass as claimed in claim 1, wherein the proportion of cerine-zirconia in the binder ranges between 0.1 and 1, preferably between 0.5 and 1, the other elements of the binder being selected from the group consisting of alumina, aluminates, YSZ and perovskites.

6) Redox mass as claimed in claim 1, characterized in that it consists of powder, balls, extrudates, or of a washcoat deposited on a monolith type substrate.

7) Application of the redox mass as claimed in claim 1 to a redox process using an oxidation reactor and a reduction reactor both operated with a circulating bed.

8) Application of the redox mass as claimed in claim 1 to a redox process using a rotary reactor.

9) Application of the redox mass as claimed in claim 1 to a redox process using a simulated rotary reactor.
